(19) United States
(12) Patent Application Publication
(10) Pub. No.: US 2011/0076145 A1
(43) Pub. Date: Mar. 31, 2011

(54) HIGH EFFICIENT COMPOUNDED WIND POWER SYSTEM

(76) Inventor: Chen-Ming HONG, Taipei City (TW)

(21) Appl. No.: 12/568,957

(22) Filed: Sep. 29, 2009

(51) Int. Cl. F03D 11/00; F03D 1/00

(52) U.S. Cl. 416/117

(57) ABSTRACT

A high efficient compounded wind power system comprises a wind power unit including a wind hood, a plurality of fan blades installed externally to said wind hood, a wind power unit driving main transmission shaft installed behind said wind hood, a driving gear installed on said main transmission shaft to form a separation with said wind hood, and a compound unit installed on said main transmission shaft locating behind said wind hood for mutual driving and mutual power transmission with said wind power unit to include a gravity wheel, a plurality of gravity shaft arms installed externally to said gravity wheel, and a plurality of swingable gravity wheels which are connected respectively with each gravity shaft arm at the end whereof. As such, high efficient wind power is produced to allow the present wind power generation equipments to operate eternally and continuously with a better energy economic effectiveness.

### FIELD OF THE INVENTION

The invention is related to a kind of wind power system, and is more particularly to a high efficient compounded wind power system which improves the conditions of that present wind power generation equipments are unable to generate power in too small winds.

### BACKGROUND OF THE INVENTION

Wind power has been used to produced power needed by us in wind applications, wherein it has the advantages of clean, zero pollution, low cost and unlimited supply for unlimited consumptions.

The present wind power generation equipment includes a wind power unit installed on a base, wherein it comprises a wind hood, a plurality of fan blades installed externally to said wind hood, a wind power unit driving main transmission shaft installed behind said wind hood, a wind power unit driving gear installed on said main transmission shaft to form a separation with said wind hood, whereby said fan blades are blown by wind to drive said wind power unit driving main transmission shaft to further drive a generator for power generation.

However, the inventor has surveyed and further analyzed reactions in the market to discover that the structure of present wind power generation equipments is unable to make fan blades rotated in no wind, light wind or low wind speed conditions for continuous stable power generation, therefore structure of present wind power generation equipments has imperfections which shall be further improved.

### SUMMARY OF THE INVENTION

The main purpose of the invention is to disclose a high efficient compounded wind power system which improves the imperfections of present wind power generation equipments unable to generate power in too small winds.

To achieve above said purposes, the high efficient compounded wind power system is invented by taking the following methods:

A wind power unit installed on a base, wherein it comprises a wind hood, a plurality of fan blades installed externally to said wind hood, a wind power unit driving main transmission shaft installed behind said wind hood, and a wind power unit driving gear installed said main transmission shaft to form a separation with said wind hood; and

A compound unit is installed on said wind power unit driving main transmission shaft and is located behind said wind hood for mutual driving and mutual power transmission with said wind power unit, wherein it comprises a gravity wheel, a plurality of gravity shaft arms installed externally to said gravity wheel, and a plurality of swingable gravity wheels which are connected respectively with each gravity shaft arm at the end whereof.

Therefore, effectiveness of the invention is obtained by forming a mutual driving and mutual power transmission relationship between the wind power unit and the compound unit, thereby a high efficient wind power is produced to allow the present wind power generation equipments to operate eternally and continuously with a better energy economic effectiveness.

### BRIEF DESCRIPTION OF THE DRAWINGS

FIG. 1 is an outlook schematic view showing a preferred embodiment of the invention.

FIG. 2 is a outlook schematic view showing a wind power unit in a preferred embodiment of the invention.

FIG. 3 is an outlook schematic view showing a gravity arm in a preferred embodiment of the invention.

FIG. 4 is an outlook schematic view shown in other direction of FIG. 3.

FIG. 5 is an outlook schematic view showing a compound unit in a preferred embodiment of the invention.

FIG. 6 is a schematic view showing an operation mode of gravity arm in a preferred embodiment of the invention.

FIG. 7 is a flow diagram showing the operating mode of a preferred embodiment of the invention.

### DETAILED DESCRIPTION OF THE PREFERRED EMBODIMENTS

The detail content of the invention is described below along with accompanying Figs.:

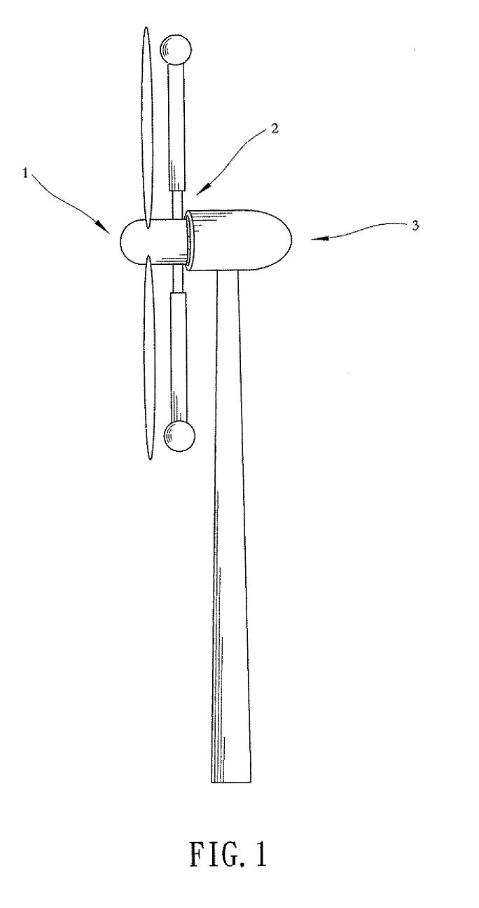

A preferred embodiment of the invented high efficient compounded wind power system as shown in FIG. 1 comprises: a base 3 is installed with a wind power unit 1 thereon and a compound unit 2 to mutually drive and transfer power with said wind power unit 1, thereby to obtain a better efficient wind power generation output.

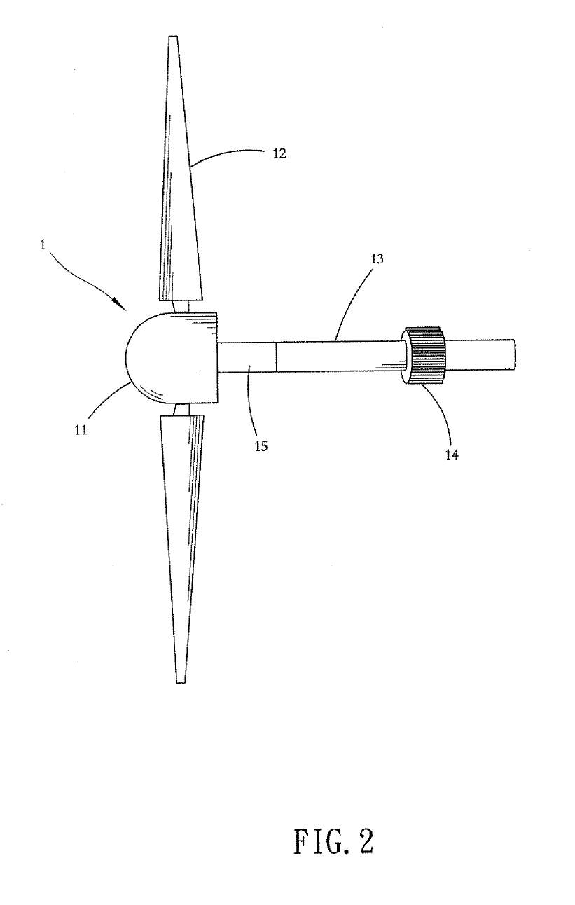

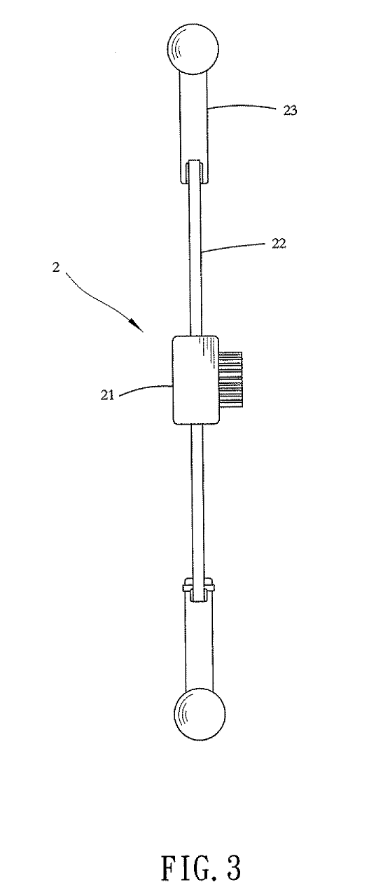

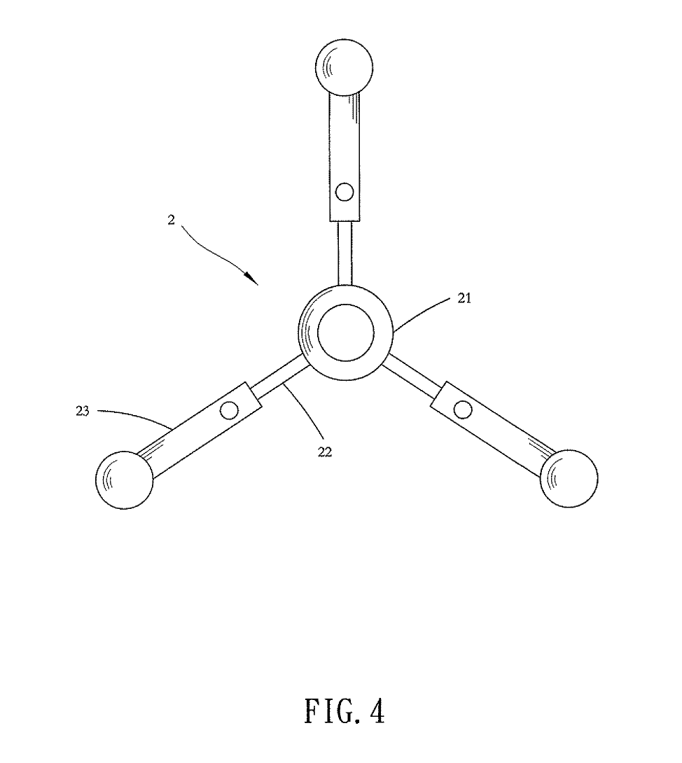

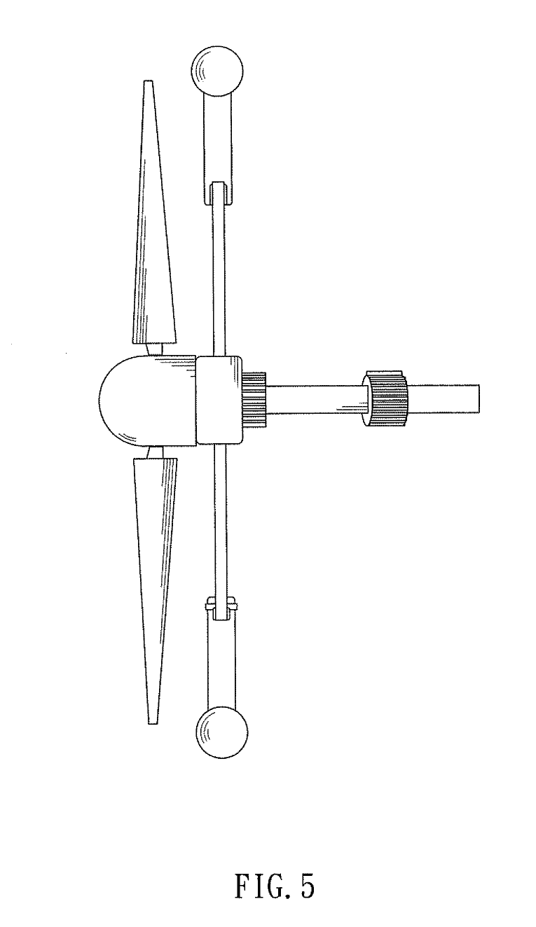

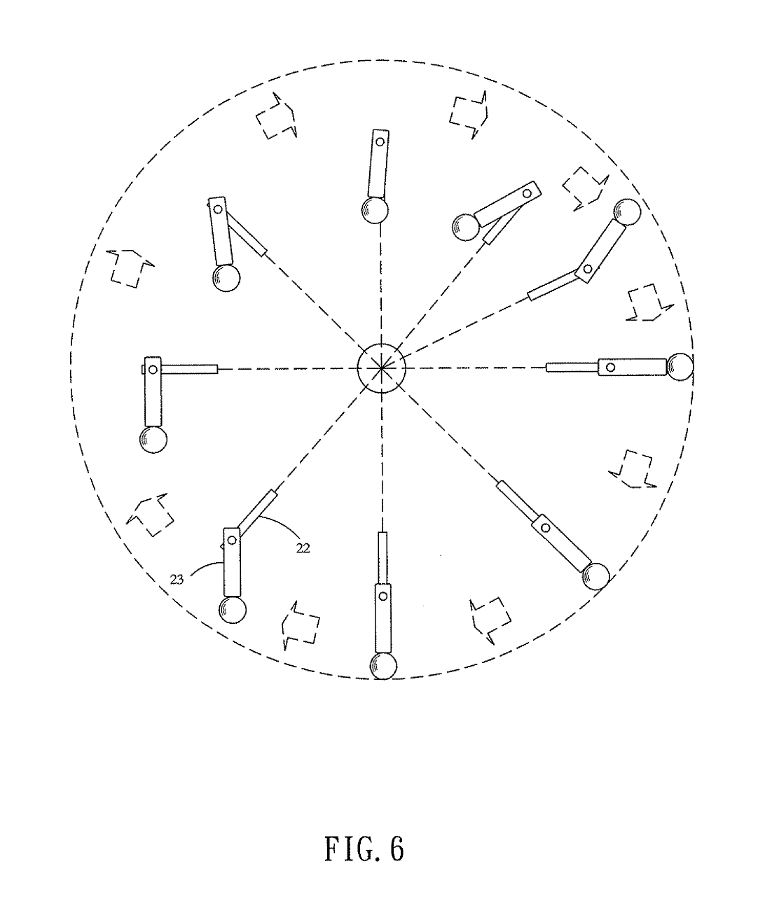

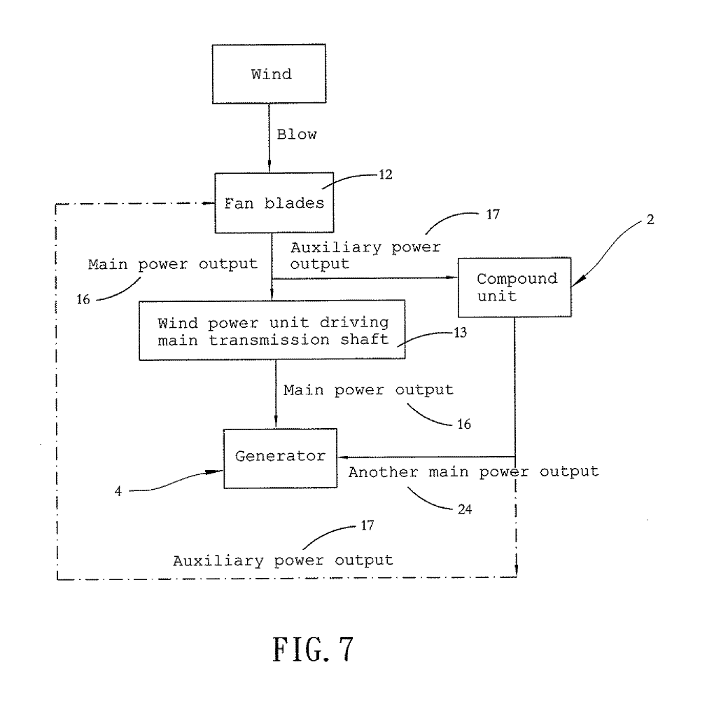

As shown in FIGS. 2 to 7, said wind power unit 1 includes a wind hood 11, a plurality of fan blades 12 installed externally to said wind hood 11, a wind power unit driving main transmission shaft 13 installed behind said wind hood 11, and a wind power unit driving gear 14 installed said main transmission shaft 13 to form a separation with said wind hood 11.

Said compound unit 2 is installed on said wind power unit driving main transmission shaft 13 and is located behind said wind hood 11, wherein it comprises: a gravity wheel 21, a plurality of gravity shaft arms 22 installed externally to said gravity wheel 21, and a plurality of swingable gravity wheels 23 which are connected respectively with each gravity shaft arm 22 at the end whereof.

A sleeve area 15 for inserting said gravity wheel 21 is formed on said wind power unit driving main transmission shaft 13 in the vicinity behind said wind hood 11 thereof.

Said fan blades 12 are blown by wind to rotate thereby to produce a main power output 16 and an auxiliary power output 17, wherein said main power output 16 is transmitted to wind power unit driving main transmission shaft 13, whereby said main power output 16 is continuously transmitted by said wind power unit driving main transmission shaft 13 to drive the generator 4.

Said auxiliary power output 17 is transmitted to said compound unit 2, whereby gravity wheel 21 and gravity shaft arms 22 of said compound unit 2 are rotated synchronously, and each gravity wheel 23 installed at the end of each gravity shaft arm 22 are also swung synchronously.

When said gravity wheels 23 are swung synchronously, another main power output 18 similar to above said main power output 16 is generated synchronously, and another main power output 24 is further used to drive above said generator 4.

When said gravity wheels 23 are swung synchronously, above said auxiliary power output 17 is continuously transmitted to wind power unit 1 to make the plurality of fan blades 12 rotated continuously.

Said gravity wheels 23 appear in different angles during swinging process and is moving up and down at a fixed height. So called “High Efficient Wind Power” is produced by the high efficient compounded wind power system, wherein said high efficient compounded wind power system is to additionally attach one compound unit 2 on the existing wind power generation equipment (i.e. wind power unit 1), thereby to form mutual driving and mutual power transmission between the said two units so as to achieve an eternal and continuous operation with better energy economic effectiveness.

In essence, when said fan blades 12 is blown by the wind to rotate, a main power output 16 and an auxiliary power output 17 are produced, in case of small wind or no wind, the fan blades 12 are unable to rotate, at the moment, the auxiliary power output 17 is fed back by the installed compound unit 2 to fan blades 12 and drives said wind power unit 1 to rotate, thereby the present wind power generation equipment will not be annoyed by stopping rotation in the future, and the existing energy consuming problems such as friction forces, air resistances and gravity, etc. in the compound unit 2 can be completely overcome.

Said compound unit 2 is driven by said wind power unit 1, wherein said compound unit 2 is through rotation of said gravity shaft arms 22 as well as swinging and up and down movements of gravity wheels 23 to produce potential energy, gravity acceleration and inertia, whereby the potential energy is converted to mechanical power which is further converted to kinetic energy or electric power.

Therefore, by utilizing the interactive power transmission and feedback operating status of the “high efficient wind power” characterized high efficient compounded wind power system, though operation of wind power unit 1 has to rely on the wind to push said fan blades 12 for initial operation, it is automatically operated afterwards, wherein even in no wind, light wind or low wind conditions, the present imperfections for present wind power generation equipments being unable to generate power at such said conditions can be improved to allow said fan blades 12 to operate at 24 hour-days incessantly, thereby the operating effectiveness of present wind power generation equipment can be sufficiently promoted to maintain highly stable energy output, and in case of component failure, it can be replaced or repaired and the said operation can be continued again.

As summarized from above descriptions, the invention has the characteristics of all day long continuous operation, operating effectiveness promotion for present wind power generating equipments and a highly stable energy production, etc. in comparing with present structure of wind power generation equipments, therefore it is a relatively good invention meeting the requirement for new type patent application which is applied for approval herein according to the law.

The invention is described in detail using above said preferred embodiments, however the above said ones are only purposed to let those skilled of the arts to understand the invention, and is not intended to limit the application range of the invention. Therefore, all equivalent changes or modifications referring to said characteristics and spirits in forms and structures claimed by the invention shall be include in the scope of claims in the invention.

What is claimed is:

1. A high efficient compounded wind power system comprises:
A wind hood, a plurality of fan blades installed externally to said wind hood, a wind power unit driving main transmission shaft installed behind said wind hood, and a wind power unit driving gear installed said main transmission shaft to form a separation with said wind hood; and
A compound unit is installed on said wind power unit driving main transmission shaft and is located behind said wind hood for mutual driving and mutual power transmission with said wind power unit, wherein it comprises a gravity wheel, a plurality of gravity shaft arms installed externally to said gravity wheel, and a plurality of swingable gravity wheels which are connected respectively with each gravity shaft arm at the end whereof.

2. The high efficient compounded wind power system as claimed in claim 1, wherein a sleeve area for inserting said gravity wheel is formed on said wind power unit driving main transmission shaft in the vicinity behind said wind hood thereof.

3. A high efficient compounded wind power system as claimed in claim 1, wherein said fan blades are blown by wind to rotate thereby to produce a main power output and an auxiliary power output, wherein said main power output is transmitted to wind power unit driving main transmission shaft, whereby said main power output is continuously transmitted by said wind power unit driving main transmission shaft to drive the generator.

4. The high efficient compounded wind power system as claimed in claim 3, wherein said auxiliary power output is transmitted to said compound unit, whereby gravity wheel and gravity shaft arms of said compound unit are rotated synchronously, and each gravity wheel installed at the end of each gravity shaft arm are also swung synchronously.

5. The high efficient compounded wind power system as claimed in claim 4, wherein when said gravity wheels are swung synchronously, another main power output similar to above said main power output is generated synchronously, and another main power output is further used to drive above said generator.

6. The high efficient compounded wind power system as claimed in claim 4, wherein when said gravity wheels are swung synchronously, above said auxiliary power output is continuously transmitted to wind power unit to make the plurality of fan blades rotated continuously.

7. The high efficient compounded wind power system as claimed in claim 1, wherein said gravity wheels appear in different angles during swinging process and is moving up and down at a fixed height.
